(19) United States
(12) Patent Application Publication
(10) Pub. No.: US 2015/0121065 A1
(43) Pub. Date: Apr. 30, 2015

(54) ELECTRONIC DEVICE AND ANTIPIRACY PROTECTING METHOD

(71) Applicant: Chiun Mai Communication Systems, Inc., New Taipei (TW)

(72) Inventor: CHO-JAN CHEN, New Taipei (TW)

(73) Assignee: CHIUN MAI COMMUNICATION SYSTEMS, INC., New Taipei (TW)

(21) Appl. No.: 14/061,932

(22) Filed: Oct. 24, 2013

(51) Int. Cl. H04L 29/06

(52) U.S. Cl. CPC H04L 63/062
USPC 713/155

(57) ABSTRACT

In a method of protecting copyright of a digital media file in an electronic device, the electronic device receives a request for downloading the digital media file, from a recipient electronic device, the electronic device requires the recipient electronic device, to provide information of the recipient electronic device, the electronic device further requests a third-party authorization system, to allocate a key for the digital media file according to the information, once the electronic device locks the digital media file using the key, the electronic device sends the locked digital media file to the recipient electronic device.

### BACKGROUND

1. Technical Field

Embodiments of the present disclosure relate to copyright protection technology, and more particularly to an electronic device and a method for protecting copyright of a digital media file using the electronic device.

2. Description of Related Art

Generally, copyright of a digital media file (e.g., an audio file) may be infringed by illegal users when the digital media file is not well kept by an owner. What is needed, therefore, is an electronic device and an antipiracy protecting method to overcome the aforementioned problem.

### BRIEF DESCRIPTION OF THE DRAWINGS

FIG. 1 is a block diagram of one embodiment of a first electronic device and a second electronic device including a protecting system.

FIG. 2 is a block diagram of function modules of the protecting system included in the first and second electronic devices of FIG. 1.

FIG. 3 is a first flowchart of one embodiment of a protecting method to protect copyright of a digital media file.

FIG. 4 is a second flowchart of one embodiment of the protecting method to protect copyright of the digital media file.

FIG. 5 illustrates an example of second random codes generated by a third-party authorization system.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word module, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

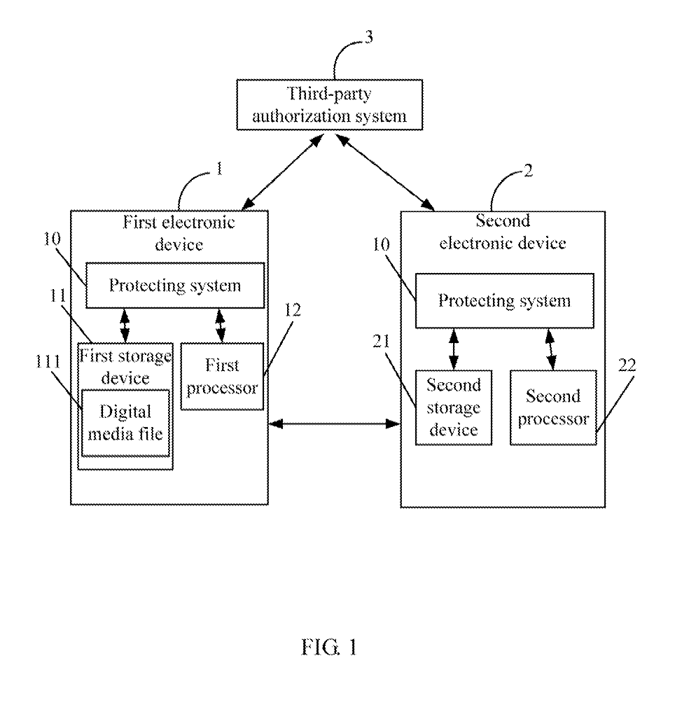

FIG. 1 is a block diagram of one embodiment of a first electronic device 1 in communication with a second electronic device 2. The first electronic device 1 and the second electronic device 2 are in further communication with a third-party authorization system 3. The first electronic device 1 and the second electronic device 2 may be mobile phones, personal digital assistants (PDAs), tablet computers, or other computing devices. In one embodiment, the third-party authorization system 3 can be included in a third electronic device, which is not shown in the FIG. 1

In one embodiment, both of the first electronic device 1 and the second electronic device 2 include a protecting system 10. The first electronic device 1 further includes, but is not limited to a first storage device 11 and a first processor 12. The second electronic device 1 further includes, but is not limited to a second storage device 21 and a second processor 22.

In some embodiments, the protecting system 10 prestores a digital media file (e.g., a music or video file) 111 in the first storage device 11. The second electronic device 2 requests to obtain the digital media file 111 from the first storage device 11. The third-party authorization system 3 interacts with the protecting system 10, to protect copyright of the digital media file 111. Details will be given below.

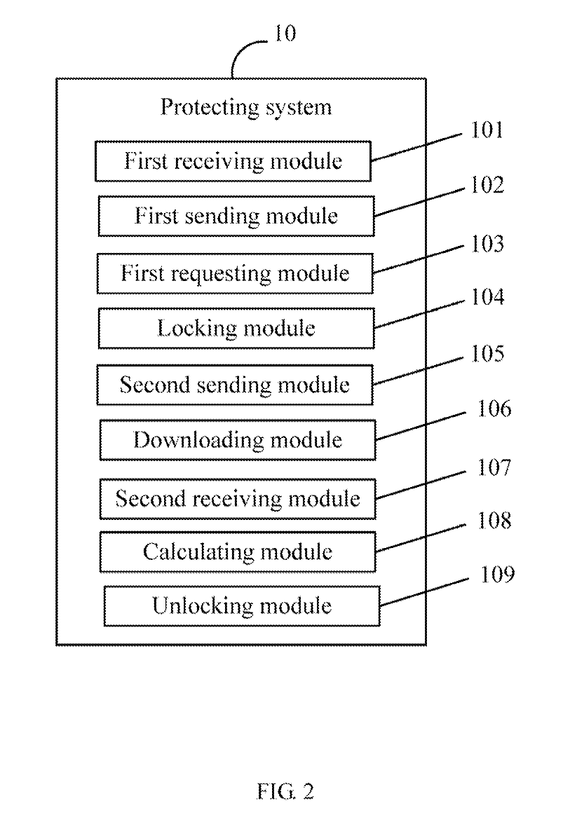

FIG. 2 is a block diagram of function modules of the protecting system 10 included in the first electronic device 1 and the second electronic device 2 of FIG. 1. In one embodiment, the protecting system 10 may include a first receiving module 101, a first sending module 102, a first requesting module 103, a locking module 104, a second sending module 105, a downloading module 106, a second receiving module 107, a calculating module 108, and an unlocking module 109. The modules 101˜109 include computerized codes in the form of one or more programs that may be stored in each of the first storage device 11 and the second storage device 21. The computerized code includes instructions that are executed by the first processor 12 or by the second processor 22 to provide functions for the modules.

As mentioned above, the protecting system 10 prestores the digital media file 111 in the first storage device 11. The second electronic device 2 requests to obtain the digital media file 111 from the first storage device 11. In this embodiment, it is assumed that the first electronic device 1 acts as a sender electronic device to send the digital media file 111 to the second electronic device 2, and the second electronic device 2 acts as a recipient electronic device to receive the digital media file 111.

In other embodiments, when the processing system 10 prestores the digital media file 111 in the second storage device 21, and the first electronic device 1 requests to obtain the digital media file 111, then the second electronic device 2 acts as the sender electronic device to send the digital media file 111 to the first electronic device 1, and the first electronic device 1 acts as the recipient electronic device to receive the digital media file 111.

When the first electronic device 1 acts as the sender electronic device, the first processor 12 of the first electronic device 1 executes the modules 101-104, and the second processor 22 of the second electronic device 2 executes the modules 105-109.

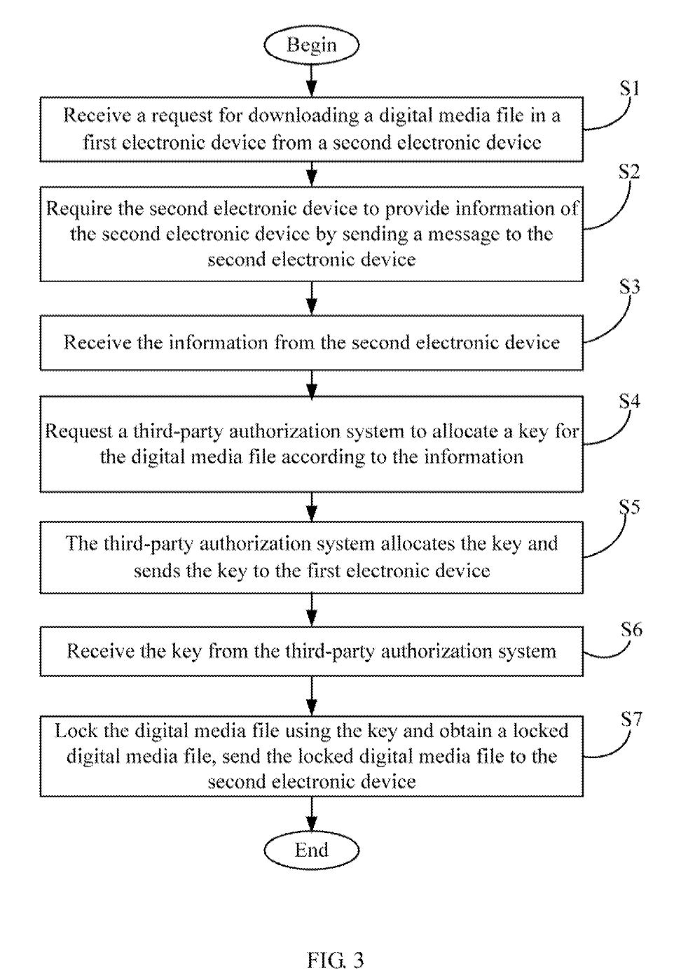

FIG. 3 is a first flowchart of one embodiment of a protecting method to protect copyright of the digital media file 111. Depending on the embodiment, additional blocks may be added, others deleted, and the ordering of the blocks may be changed.

In step S1, the first receiving module 101 receives a request for downloading the digital media file 111 from the second electronic device 2.

In one embodiment, the second electronic device 2 sends the request together with an identifier of the digital medial file 111 to the first electronic device 1. In this embodiment, the identifier of the digital medial file 111 is a uniform resource locator (URL) allocated by the first electronic device 1.

In step S2, the first sending module 102 requires the second electronic device 2 to provide information of the second electronic device 2, by sending a message to the second electronic device 2.

In one embodiment, the message is in form of a dialog box sent by the sending module 102, and the information of the second electronic device 2 includes a first random code generated by the second electronic device 2 and an identification code of the second electronic device 2.

In one embodiment, the first random code includes numbers, letters and/or special characters. The identification code may be an Internet Protocol (IP) address or a Media Access Control (MAC) address of the second electronic device 2.

In step S3, the first receiving module 101 further receives the information (e.g., the first random code and the identification code) from the second electronic device 2.

In step S4, the first requesting module 103 requests the third-party authorization system 3 to allocate a key for the digital media file 111 according to the information. In one embodiment, the first requesting module 103 further sends the identifier of the digital media file 111 to the third-party authorization system 3.

In step S5, the third-party authorization system 3 generates a second random code, and generates the key according to a preset key algorithm using the first random code and the second random code. The third-party authorization system 3 further sends the key to the first electronic device 1.

In one embodiment, the second random code includes numbers, letters and/or special characters, and the preset key algorithm is a A3 algorithm. The third-party authorization system 3 further records the second random code according to the identification code of the second electronic device 2 and the identifier of the digital media file 111.

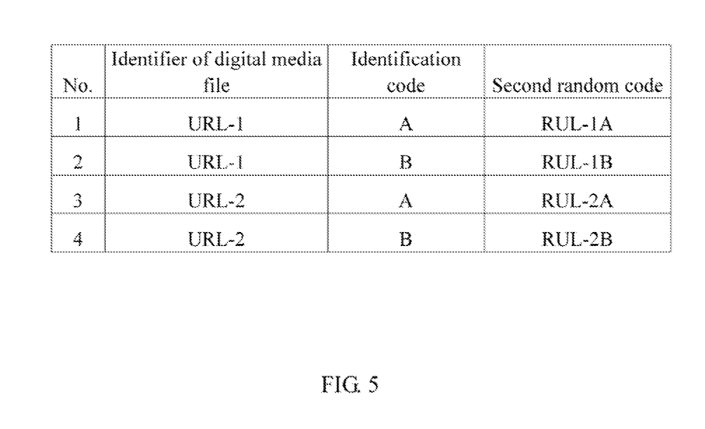

For example, as shown in FIG. 5, the third-party authorization system 3 records the second random code (e.g., URL-1A) according to the identification code (e.g., A) of the first electronic device 1 and the identifier (e.g., URL-1) of the digital media file 111.

In step S6, the first receiving module 101 receives the key from the third-party authorization system 3.

In step S7, the locking module 104 locks the digital media file 111 using the key, thus forming a locked digital media file, and sends the locked digital media file to the second electronic device 2.

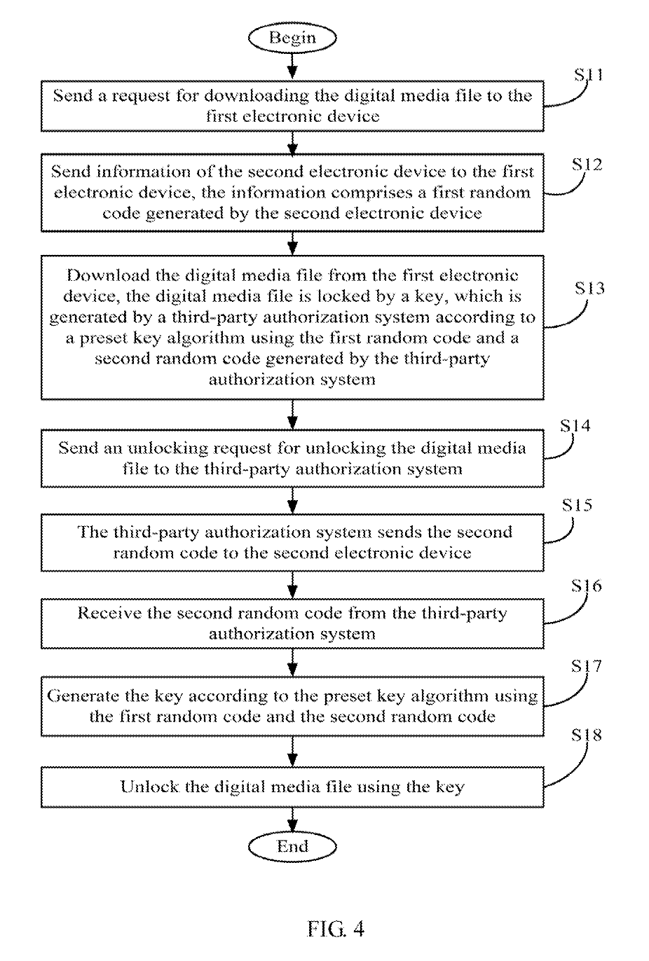

FIG. 4 is a second flowchart of one embodiment of the protecting method to protect copyright of the digital medial file 111. Depending on the embodiment, additional blocks may be added, others deleted, and the ordering of the blocks may be changed.

In step S11, the second sending module 105 sends the request for downloading the digital media file 111 to the first electronic device 1 (e.g., the sender electronic device).

In one embodiment, the second sending module 105 sends the request together with the identifier of the digital medial file 111 to the first electronic device 1. As mentioned above, the identifier of the digital medial file 111 is the URL allocated by the first electronic device 1.

In step S12, the second sending module 105 sends the information of the second electronic device 2 (e.g., the recipient electronic device) to the first electronic device 1. The second sending module 105 further stores the information in the second storage device 21.

As mentioned above, the information includes the first random code generated by the second electronic device 2 and the identification code of the second electronic device 2. The first random code includes numbers, letters and/or characters, and the identification code may be the IP address or MAC address.

As mentioned above, when the first electronic device 1 receives the information, the first electronic device 1 sends the information to the third-party authorization system 3. The third-party authorization system 3 generates the key according to the preset key algorithm using the first random code and the second random code. The third-party authorization system 3 further sends the key to the first electronic device 1, and the first electronic device 1 locks the digital media file 111 using the key and obtains the locked digital media file.

In step S13, the downloading module 106 downloads the locked digital media file 111 from the first electronic device 1 (i.e., the sender electronic device).

In step S14, the second sending module 105 sends an unlocking request for unlocking the locked digital media file 111 to the third-party authorization system 3.

In one embodiment, the second sending module 105 sends the unlocking request together with the identifier of the locked digital media file 111, and the identification code of the second electronic device 2, to the third-party authorization system 3.

For example, the second sending module 105 sends the unlocking request together with the identifier (e.g., URL-1) and the identification code (e.g., A) to the third-party authorization system 3.

In step S15, the third-party authorization system 3 determines the second random code and sends the second random code to the second electronic device 2.

For example, as shown in FIG. 5, the third-party authorization system 3 determines the second random code (RUL-1A), according to the identifier (e.g., URL-1) and the identification code (e.g., A). The third-party authorization system 3 further sends the second random code (RUL-1A) to the second electronic device 2.

In step S16, the second receiving module 107 receives the second random code sent from the third-party authorization system 3.

In step S17, the calculating module 108 generates the key according to the preset key algorithm using the first random code and the second random code.

In step S18, the unlocking module 109 unlocks the locked digital media file 111 using the key.

Although embodiments of the present disclosure have been specifically described, the present disclosure is not to be construed as being limited thereto. Various changes or modifications may be made to the present disclosure without departing from the scope and spirit of the present disclosure.

What is claimed is:

1. A method of protecting copyright of a digital media file using a first electronic device, the method comprising:
receiving, from a second electronic device, a request for downloading the digital media file stored in the first electronic device;
requiring the second electronic device to provide information of the second electronic device by sending a message to the second electronic device;
receiving the information from the second electronic device;
requesting a third-party authorization system to allocate a key for the digital media file according to the information;
receiving the key from the third-party authorization system; and
locking the digital media file using the key to create a locked digital media file, and sending the locked digital media file to the second electronic device.

2. The method according to claim 1, wherein the information comprises a first random code generated by the second electronic device and an identification code of the second electronic device.

3. The method according to claim 2, wherein the key is generated by the third-party authorization system according to a preset key algorithm using the first random code and a second random code generated by the third-party authorization system, the third-party authorization system further records the second random code according to the identification code and an identifier of the digital media file.

4. A method of protecting copyright of a digital media file of a first electronic device, using a second electronic device, the method comprising:
sending a request for downloading the digital media file to the first electronic device;
sending information of the second electronic device to the first electronic device, the information comprising a first random code generated by the second electronic device;
downloading the digital media file from the first electronic device, the digital media file being locked by a key, which is generated by a third-party authorization system according to a preset key algorithm using the first random code and a second random code generated by the third-party authorization system;
sending an unlocking request for unlocking the digital media file to the third-party authorization system;
receiving the second random code from the third-party authorization system;
generating the key according to the preset key algorithm using the first random code and the second random code; and
unlocking the digital media file using the key.

5. The method according to claim 4, wherein the information further comprises an identification code of the second electronic device, the third-party authorization system records the second random code according to the identification code and an identifier of the digital media file.

6. An electronic device, comprising:
at least one processor; and
a storage device storing one or more computer-readable programs, which when executed by the at least one processor, causes the at least one processor to:
receive, from a recipient electronic device, a request for downloading the digital media file stored in the electronic device;
require the recipient electronic device to provide information of the recipient electronic device by sending a message to the recipient electronic device;
receive the information from the recipient electronic device;
request a third-party authorization system to allocate a key for the digital media file according to the information;
receive the key from the third-party authorization system; and
lock the digital media file using the key to create a locked digital media file, send the locked digital media file to the recipient electronic device.

7. The electronic device according to claim 6, wherein the information comprises a first random code generated by the recipient electronic device and an identification code of the recipient electronic device.

8. The electronic device according to claim 6, wherein the key is generated by the third-party authorization system according to a preset key algorithm using the first random code and a second random code generated by the third-party authorization system, the third-party authorization system further records the second random code according to the identification code and an identifier of the digital media file.
